(19) United States
(12) Patent Application Publication
(10) Pub. No.: US 2012/0018664 A1
(43) Pub. Date: Jan. 26, 2012

(54) METHOD OF PRODUCING A LEAD ZIRCONIUM TITANATE-BASED SINTERED BODY, LEAD ZIRCONIUM TITANATE-BASED SINTERED BODY, AND LEAD ZIRCONIUM TITANATE-BASED SPUTTERING TARGET

(75) Inventors: Shouichi HASHIGUCHI, Chiba-Ken (JP); Poong KIM, Chiba-Ken (JP); Takanori MIKASHIMA, Chiba-Ken (JP)

(73) Assignee: Ulvac, Inc., Kanagawa (JP)

(21) Appl. No.: 13/252,317

(22) Filed: Oct. 4, 2011

Related U.S. Application Data
(62) Division of application No. 12/339,227, filed on Dec. 19, 2008, now abandoned.

(30) Foreign Application Priority Data
Dec. 27, 2007 (JP) 2007-336437

(51) Int. Cl. C04B 35/64

(52) U.S. Cl. 252/62.9 PZ

(57) ABSTRACT

To obtain a method of producing a high-density lead zirconium titanate-based sintered body having uniform crystalline phases and containing a large amount of PbO, provided is a method of producing a lead zirconium titanate-based sintered body, including: producing a pre-sintered body by sintering raw material powder of lead zirconium titanate having a stoichiometric composition at a temperature of 900° C. or more and 1,200° C. or less; pulverizing the pre-sintered body; producing lead-excessive mixed powder by adding PbO powder to powder obtained by pulverizing the pre-sintered body; and sintering the lead-excessive mixed powder at a temperature lower than the sintering temperature of the pre-sintered body. Because the sintering process is divided into two stages, a high-density (e.g., 95% or more) PZT sintered body constituted only of PZT having a stoichiometric composition in which PbZrO₃, PbTiO₃, ZrO₂, TiO₂, PbO, and other intermediate compounds are absent, and excessive PbO can be obtained.

### CROSS-REFERENCE TO RELATED APPLICATIONS

This application is a divisional of U.S. patent application Ser. No. 12/339,227 filed on Dec. 19, 2008 which claims the benefit and priority of Japanese Application No. 2007-336437 filed Dec. 27, 2007. The entire disclosures of each of the above applications are incorporated herein by reference.

### FIELD

The present invention relates to a method of producing a lead zirconium titanate-based sintered body having a perovskite structure that excessively contains a lead oxide (PbO) component, a lead zirconium titanate-based sintered body, and a lead zirconium titanate-based sputtering target.

### BACKGROUND

Lead zirconium titanate (hereinafter, also referred to as “PZT”) has large permittivity, piezoelectricity, and ferroelectricity, and is in wide industrial use as a thinfilm device among fields of a piezoelectric device, a dielectric memory, an actuator, a sensor, and the like. A sputtering method is often used as a method of producing a PZT thinfilm.

In the case of depositing PZT by the sputtering method, however, there is a problem that a content of PbO (lead oxide) contained in the film is reduced as compared to that contained in a target composition. Specifically, for obtaining a highly-oriented film of PZT, a substrate on which PZT is deposited needs to be heated during deposition or after the deposition. In this case, a phenomenon in which PbO contained in the PZT (Pb(ZrₓTi₁₋ₓ)O₃) composition is decomposed by the heat, and Pb or PbO itself is volatilized occurs. Therefore, in the case of depositing PZT by the sputtering method, the target composition and the thin film composition are differed.

When using PZT for the dielectric memory, for example, since properties of a remanent polarization, coercive electric field, and the like become important, it is desirable that the PZT thinfilm has a stoichiometric composition. However, when using a target having the stoichiometric composition, the film composition results in a PbO diminution as compared to the stoichiometric composition.

In this regard, for compensating the content reduced by the volatilization of the PbO, a technique of excessively adding PbO in a target is known. By producing a target using a bulk material formed of PZT excessively containing PbO (hereinafter, referred to as PbO-excess PZT), a thinfilm having a stoichiometric composition can be deposited.

Specifically, Japanese Patent Application Laid-open No. Hei 11-335825 (paragraph [0035]) discloses a method of producing a PZT sintered body that involves mixing and pre-sintering (calcining) raw material powder excessively containing Pb, pulverizing the pre-sintered body thereafter, and carrying out primary sintering and secondary sintering at a temperature higher than the pre-sintering temperature. Moreover, Japanese Patent Application Laid-open No. Hei 11-1367 (paragraphs [0011] and [0012]) discloses a method of producing a PZT sintered body that involves pre-sintering raw material powder having a stoichiometric composition at 800° C., mixing Pb₃O₄ powder as an excessive lead oxide thereafter, and sintering the resultant at 1,100° C. Furthermore, Japanese Patent Application Laid-open No. Hei 7-18427 discloses a technique in which, focusing on a crystalline structure of Pb, a main body of the excessive PbO has a tetragonal system crystalline structure.

Meanwhile, the following conditions are required for a quality of a sputtering target. First, a crystalline organization distribution needs to be fine and uniform, and a composition distribution also needs to be uniform. Second, purity needs to be controlled. Finally, a relative density needs to be as high as 95% or more in a case of using powder as a raw material. Here, the relative density refers to a ratio of a density of a porous body to a density of a material having the same composition as the porous body but with no pores (the same holds true in descriptions below).

The sputtering target formed of PZT that excessively contains PbO needs to have a sufficient PbO content and a high-density and uniform crystalline structure.

However, because PbO has poor stability in terms of heat as described above, there is a problem that, when the PZT mixed powder excessively containing PbO as compared to the stoichiometric composition is sintered at as high a temperature as 1,000° C. or more as described in Japanese Patent Application Laid-open No. Hei 11-335825, a PbO diminution becomes large and composition control becomes difficult. Moreover, it becomes difficult to increase the relative density of the sintered body due to the loss of PbO.

Japanese Patent Application Laid-open No. Hei 11-335825 also discloses a method of repeating sintering and pulverization a predetermined number of times, as a measure to uniformize the crystalline organization. However, there arises a problem that the compositions may become non-uniform as the number of times the sintering/pulverization are carried out increases, or a new issue concerning an increase in impurities may be caused due to an increase in the number of processes.

Because the method disclosed in Japanese Patent Application Laid-open No. Hei 11-1367 also involves carrying out the sintering of the powder obtained by mixing the pre-sintered powder having the stoichiometric composition and the PbO powder at 1,100° C., there is a problem that composition control becomes difficult due to the reduction of PbO, and a high relative density cannot be obtained.

It should be noted that for suppressing dispersion of PbO during sintering, a method in which pre-sintering and sintering are carried out at a low temperature is conceivable. However, the sintered body obtained by this method most often has a low-density (relative density of about 70%) organization that is not formed with a complete PZT phase, contains many crystalline phases that reflect the raw material powders, and has a non-uniform composition distribution.

Furthermore, Japanese Patent Application Laid-open No. Hei 7-18427 only defines the PbO crystalline structure and does not describe about the density or PbO volatilization amount of the obtained sintered body.

As described above, when producing a PZT sintered body that excessively contains PbO, a crystalline phase from before the final sintering process remains as it is, thus causing a low density of the sintered body. In addition, due to the volatility of PbO, the composition and density of the PZT sintered body become non-uniform, and a mixed composition with a crystalline phase of three phases or more is obtained. When such poor conditions occur at the same time, there have been caused a fluctuation of a voltage/current, generation of particles, and a crack of a target during deposition by the sputtering. Therefore, a target constituted of a high-density, high-quality sintered body having uniform crystalline phases is desired to be developed.

### SUMMARY

In view of the circumstances as described above, an object of the present invention is to provide a method of producing a high-density lead zirconium titanate-based sintered body having uniform crystalline phases and containing a large amount of PbO, a lead zirconium titanate-based sintered body, and a method of producing a lead zirconium titanate-based sputtering target.

To achieve the above object, according to an embodiment of the present invention, there is provided a method of producing a lead zirconium titanate-based sintered body, including: producing a pre-sintered body by sintering raw material powder of lead zirconium titanate in which PbO, ZrO₂, and TiO₂ are mixed to have a stoichiometric composition, at a temperature of 900° C. or more and 1,200° C. or less; pulverizing the pre-sintered body; producing lead-excessive mixed powder by adding PbO powder to powder obtained by pulverizing the pre-sintered body; and sintering the lead-excessive mixed powder at a temperature lower than the sintering temperature of the pre-sintered body.

Further, according to another embodiment of the present invention, there is provided a lead zirconium titanate-based sintered body, including: a first crystalline phase formed of lead zirconium titanate having a stoichiometric composition; and a second crystalline phase formed of a lead oxide distributed in the first crystalline phase.

Furthermore, according to another embodiment of the present invention, there is provided a lead zirconium titanate-based sputtering target, including: a first crystalline phase formed of lead zirconium titanate having a stoichiometric composition; and a second crystalline phase formed of a lead oxide distributed in the first crystalline phase.

### DRAWINGS

FIG. 1 is a diagram showing a process flow for illustrating a method of producing a lead zirconium titanate-based (PZT) sintered body according to an embodiment of the present invention;

FIG. 2 is a graph showing an experimental result that shows an influence of a PbO supply amount on a PbO diminution in a PbO-excess PZT sintered body, that is to be described in the embodiment of the present invention;

FIG. 3 is a graph showing an experimental result that shows an influence of a sintering temperature on a relative density of and PbO content in a PZT sintered body having a stoichiometric composition, that is to be described in the embodiment of the present invention;

FIG. 4 is a graph showing an experimental result that shows an influence of the sintering temperature on the relative density of the PZT sintered body having the stoichiometric composition, that is to be described in the embodiment of the present invention;

FIG. 5 is a graph showing an experimental result that shows an influence of a forming load on the PbO content of the PZT sintered body having the stoichiometric composition, that is to be described in the embodiment of the present invention;

FIG. 6 is a graph showing an experimental result that shows an influence of the sintering temperature on the relative density of and PbO content in the PbO-excess PZT sintered body, that is to be described in the embodiment of the present invention;

FIG. 7 is a graph showing an experimental result that shows an influence of the sintering temperature on the relative density of the PbO-excess PZT sintered body in an air atmosphere and an oxygen atmosphere, that is to be described in the embodiment of the present invention;

FIG. 8 are diagrams schematically showing sintered states of the PbO-excess PZT sintered body to be described in the embodiment of the present invention;

FIG. 9 is a SEM photograph of a PbO-excess PZT sintered body sample according to the present invention;

FIG. 10 is a graph showing an experimental result that shows an influence of an average powder size of PZT on the relative density of and PbO content in the PZT sintered body having the stoichiometric composition, that is to be described in the embodiment of the present invention;

FIG. 11 is a graph showing an experimental result that shows an influence of an average powder size of PbO powder on the relative density of and PbO content in the PbO-excess PZT sintered body, that is to be described in the embodiment of the present invention;

FIG. 12 is a graph showing an experimental result that shows an influence of the forming load on the relative density of and PbO content in the PbO-excess PZT sintered body, that is to be described in the embodiment of the present invention;

FIG. 13 is a graph showing an experimental result that shows an influence of a sintering time on the relative density of and PbO content in the PbO-excess PZT sintered body at a time when mixed powder in which powder of a pre-sintered body sintered at 1,200° C. is mixed with PbO powder is preformed;

FIG. 14 is a photograph showing an outer appearance of the PbO-excess PZT sintered body sample according to the present invention;

FIG. 15 is a chart showing a result of examples of the present invention; and

FIG. 16 is a chart showing another result of the examples of the present invention.

### DETAILED DESCRIPTION

A method of producing a lead zirconium titanate-based sintered body according to an embodiment of the present invention includes: producing a pre-sintered body (green body) by sintering raw material powder of lead zirconium titanate in which PbO, ZrO₂, and TiO₂ are mixed to have a stoichiometric composition, at a temperature of 900° C. or more and 1,200° C. or less; pulverizing the pre-sintered body; producing lead-excessive mixed powder by adding PbO powder to powder obtained by pulverizing the pre-sintered body; and sintering the lead-excessive mixed powder at a temperature lower than the sintering temperature of the pre-sintered body.

Because the sintering process is divided into two stages, a high-density (e.g., 95% or more) PZT sintered body constituted only of two types of crystalline phases of PZT having a stoichiometric composition (Pb(ZrTi)O₃) in which PbZrO₃, PbTiO₃, ZrO₂, TiO₂, PbO, and other intermediate compounds are absent, and excessive PbO can be obtained.

In this embodiment of the present invention, the pre-sintered body is produced by mixing lead oxide powder, zirconium oxide powder, and titanium oxide powder at a stoichiometric composition, and sintering the mixed raw material powder at a temperature of 900° C. or more and 1,200° C. or less. Accordingly, it becomes possible to suppress PbO volatilization and increase the relative density.

Meanwhile, in the process of sintering the mixed powder in which the powder obtained by pulverizing the pre-sintered body and the lead oxide powder are mixed, the mixed powder is sintered at a temperature lower than the sintering temperature of the pre-sintered body. Accordingly, a PbO-excessive lead zirconium titanate-based sintered body in which volatilization of the added PbO is suppressed and that has a high relative density can be obtained. Moreover, since the PbO volatilization can be suppressed, composition control of the lead zirconium titanate-based sintered body is facilitated. As a result, a fine crystalline organization in which crystalline phases (two phases) are dispersed uniformly can be obtained.

By carrying out the sintering of the pre-sintered body and the sintering of the lead-excessive mixed powder in an oxidizing atmosphere, PbO volatilization can additionally be suppressed. Here, the oxidizing atmosphere refers to, for example, an air atmosphere or an oxygen gas atmosphere. An effect of suppressing the PbO volatilization is higher in the oxygen gas atmosphere than in the air atmosphere.

The lead zirconium titanate-based sintered body produced as described above includes a first crystalline phase formed of lead zirconium titanate having a stoichiometric composition, and a second crystalline phase formed of a lead oxide distributed in the first crystalline phase. In other words, a high-density lead zirconium titanate-based sintered body having a uniform chemical composition and crystalline structure and excessively containing PbO can be obtained.

Further, a lead zirconium titanate-based sputtering target according to an embodiment of the present invention includes a first crystalline phase formed of lead zirconium titanate having a stoichiometric composition, and a second crystalline phase formed of a lead oxide distributed in the first crystalline phase. When the lead zirconium titanate-based sputtering target includes two types of crystalline phases, an enlargement of crystals (>10 μm) facilitates anomalous discharge and generation of particles during sputtering. However, according to the embodiment, because the two types of crystals are fine and can be dispersed uniformly, a high-density lead zirconium titanate-based sputtering target having uniform crystalline phases and excessively containing PbO can be obtained. Furthermore, it becomes possible to suppress a fluctuation of a voltage/current, generation of particles, and a crack of a target during sputtering.

As described above, according to the present invention, a lead zirconium titanate-based sintered body with suppressed PbO volatilization and that has uniform crystalline phases and a high density, and excessively contains PbO can be obtained.

Hereinafter, an embodiment of the present invention will be described with reference to the drawings.

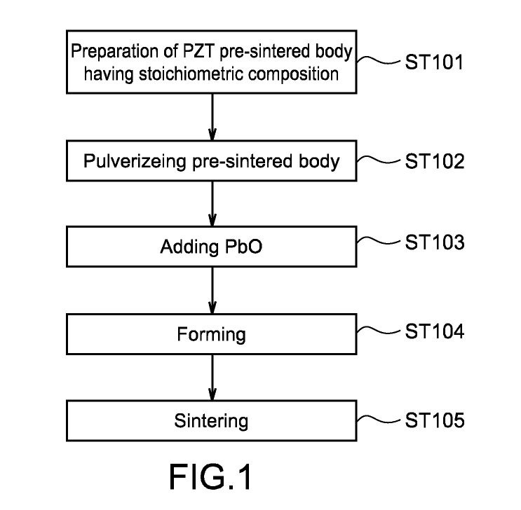

FIG. 1 is a diagram showing a process flow for illustrating a method of producing a lead zirconium titanate-based (PZT) sintered body according to the embodiment of the present invention. The method of producing a PZT sintered body of this embodiment includes producing a PZT pre-sintered body having a stoichiometric composition (Step 101), pulverizing the pre-sintered body (Step 102), adding lead oxide (PbO) (Step 103), forming (Step 104), and sintering (Step 105).

### Process of Producing Pre-Sintered Body

First, a pre-sintered body constituted of a PZT sintered body having a stoichiometric composition is produced (Step 101).

For obtaining the pre-sintered body, lead oxide, zirconium oxide, and titanium oxide are mixed at such a mix ratio as to obtain Pb(Zr_{0.52}Ti_{0.48})O₃ as raw material powder, and sintering is carried out at a temperature of 900° C. or more and 1,200° C. or less while applying a constant pressure. The pressure is desirably 500 kg/cm² or more. Accordingly, PbO volatilization can be suppressed and a Pb content can be kept constant.

Here, for producing a PZT target excessively containing PbO (hereinafter, also referred to as “PbO-excessive”), sintering has been carried out after excessively adding PbO at a time of mixing raw material powders in the related art. When applying a temperature condition normally used for sintering PZT (e.g., 1,200° C.), PbO is volatilized and dispersed to thus cause a deviation from a mix composition, that is, degradation of uniformity of an average composition or composition distribution is caused, and a value of a density is also lowered.

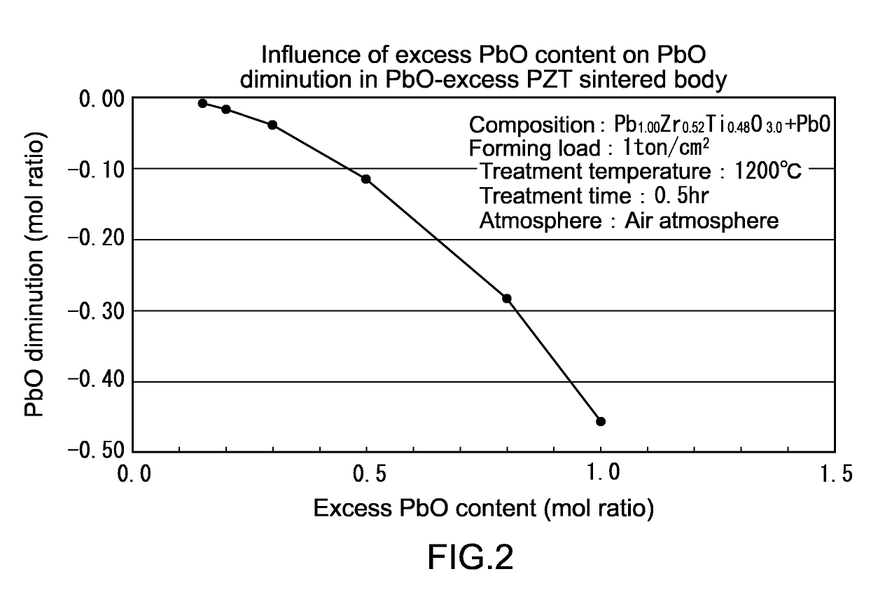

FIG. 2 is a graph showing an experimental result that shows an influence of a PbO supply amount on a PbO diminution in the PbO-excess PZT sintered body. In the experiment, PZT powder in which PbO is excessively supplied to the stoichiometric composition (Pb(Zr_{0.52}Ti_{0.48})O₃, the same holds true in descriptions below) by a mol ratio of 0.15 to 1.0 was preformed at 1 ton/cm² and sintered at 1,200° C. for 0.5 hour in an air atmosphere. A PbO diminution of PZT at this time is represented by a mol ratio.

As is apparent from FIG. 2, the larger the excess PbO content is, the larger the reduction rate of PbO is, thus resulting in a difficulty in composition control. Moreover, the smaller the excess PbO content is, the smaller the PbO diminution is. Thus, in the case where the Pb content is a stoichiometric amount, PbO is presumed to hardly decrease.

As described above, the PZT sintered body in which the raw material powders are mixed at a stoichiometric composition has a suppressed PbO diminution and is excellent in composition controllability. It should be noted that a ceramic crucible or an MgO crucible can be used for sintering the preform.

Next, a sintering temperature of the pre-sintered body will be described.

In producing the pre-sintered body in Step 101, the sintering temperature is set within the range of 900° C. or more and 1,200° C. or less. When the sintering temperature is lower than 900° C., sintering does not progress due to a low temperature, and thus a treatment time is prolonged and a density is not increased. On the other hand, when the sintering temperature is higher than 1,200° C., a speed of PbO volatilization or dispersion is increased, and thus the PbO diminution becomes large and a composition deviation from the mix composition occurs.

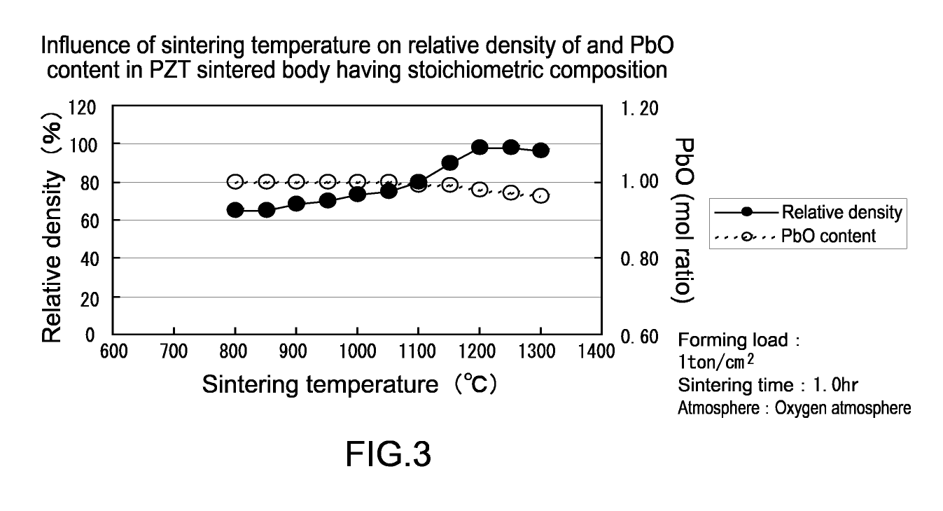

FIG. 3 is a graph showing an experimental result that shows an influence of the sintering temperature on a relative density of and PbO content in the PZT sintered body having the stoichiometric composition. In the experiment, the PZT powder having the stoichiometric composition was preformed at 1 ton/cm² and was sintered for 1 hour in an oxygen gas thereafter. In the figure, the black circles represent the relative density and the white circles represent the PbO content (mol ratio).

As shown in FIG. 3, the higher the sintering temperature is, the higher the relative density becomes, and a relative density of 95% or more can be obtained at 1,200° C. It should be noted that a tendency in which the relative density is increased no further even above the sintering temperature of 1,200° C., and the PbO diminution is rather increased can be recognized.

The sintering of the pre-sintered body in Step 101 is desirably carried out in an oxidizing atmosphere. Particularly in the oxygen gas atmosphere, the relative density is confirmed to increase at the sintering temperature of 1,100° C. or more, as compared to the air atmosphere.

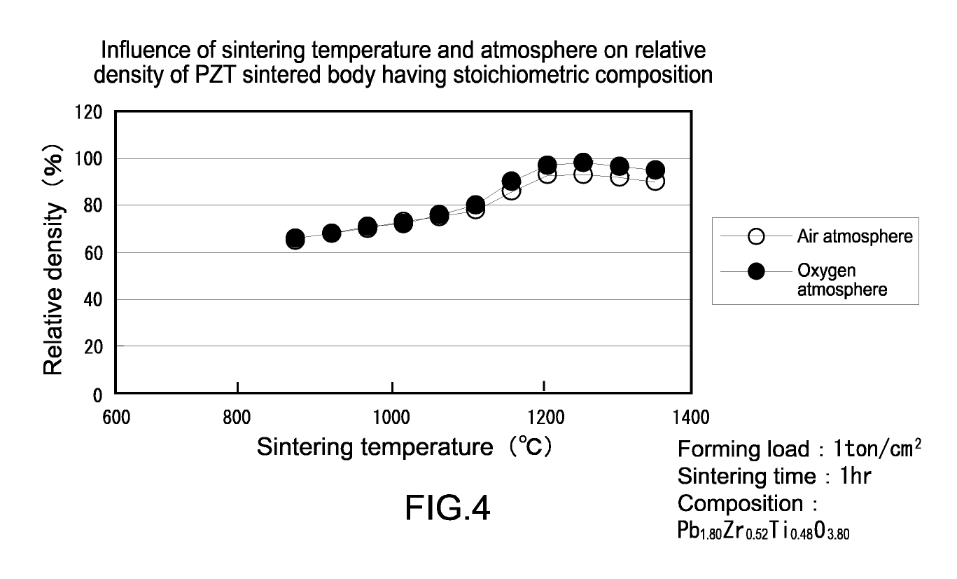

FIG. 4 shows an experimental result that shows an influence of the sintering temperature on the relative density of the PZT sintered body having the stoichiometric composition. In the experiment, the PZT powder having the stoichiometric composition was preformed at 1 ton/cm² and sintered in the air atmosphere and the oxygen atmosphere for 1 hour each thereafter. In the figure, the black circles represent the relative density in the oxygen atmosphere, and the white circles represent the relative density in the air atmosphere. It can be seen from the result shown in FIG. 4 that because the sintering atmosphere of the pre-sintered body is the oxygen atmosphere, sintering at a higher temperature becomes possible, which is a more desirable condition in which no composition fluctuation is caused.

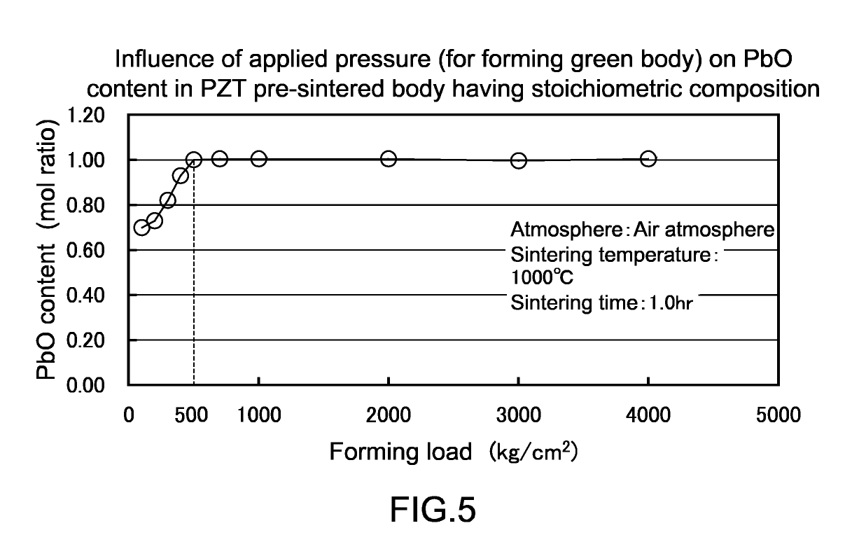

In producing the pre-sintered body in Step 101, a forming pressure of the PZT powder having the stoichiometric composition is desirably 500 kg/cm² or more. FIG. 5 is a graph showing an experimental result that shows an influence of a forming load on the PbO content of the PZT powder having the stoichiometric composition and sintered at 1,000° C. for 1 hour in the air atmosphere. As is apparent from the result shown in FIG. 5, when formed with a pressure of 500 kg/cm² or more, it can be confirmed that PbO volatilization is suppressed and the PbO content is kept constant.

### Pulverizing Process

Next, a process of pulverizing the obtained pre-sintered body is carried out (Step 102).

A suitable pulverizer is used for pulverizing the pre-sintered body. Powder of the pulverized pre-sintered body is sieved to an arbitrary size. In this embodiment, the pre-sintered body is pulverized into powder having an average powder size of 5 μm or less. Accordingly, as will be described later, it becomes possible to increase the relative density and suppress the reduction of the PbO content in the later secondary sintering with PbO powder.

### PbO Adding/Mixing Process

Next, a process of adding and mixing the powder of the pre-sintered body obtained in the pulverizing process described above and excessive PbO powder is carried out (Step 103). The powder of the pre-sintered body and the PbO powder are mixed uniformly by a rod mill or a mixer. Though the excess PbO content to be added is not particularly limited, a range is set within 0.3≦y≦1.0 when the PZT sintered body to be obtained is represented by Pb_{1+y}(ZrₓTi₁₋ₓ)O_{3+y}, for example.

### Forming/Sintering Process

Subsequently, a process of pressure-forming the mixed powder obtained by mixing the powder of the pre-sintered body and the PbO powder into a predetermined shape is carried out (Step 104). Then, a process of sintering the obtained compressed compact of the mixed powder is carried out (Step 105). It should be noted that a ceramic crucible or an MgO crucible, or a plate-like ceramics can be used for sintering the preform.

In the sintering process of Step 105, the compressed compact of the mixed powder is sintered at a temperature lower than the sintering temperature of the pre-sintered body in Step 101. In this embodiment, the sintering temperature is 850° C. or more and 1,000° C. or less, desirably 850° C. or more and 950° C. or less. A ceramic plate containing MgO can be used for sintering the compact.

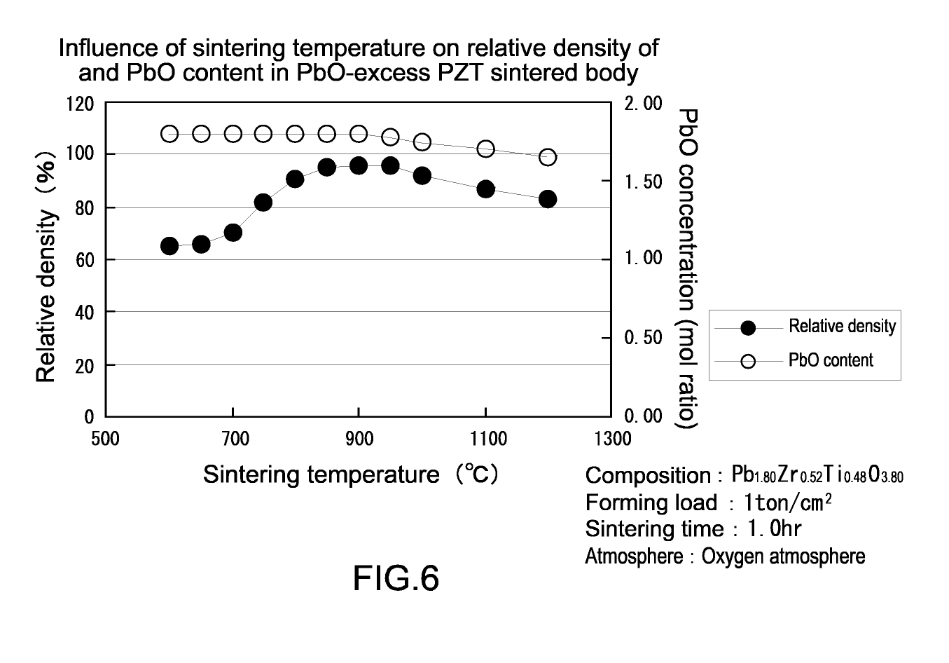

FIG. 6 is a graph showing an experimental result that shows an influence of the sintering temperature used in the sintering process of Step 105 on the relative density of and PbO content in the PbO-excess PZT sintered body. In the experiment, the mixed powder in which the excess PbO content is 0.8 in a mol ratio was preformed at 1 ton/cm² and sintered at around normal pressure for 1 hour in the oxygen atmosphere thereafter. In the figure, the black circles represent the relative density and the white circles represent the PbO diminution. As is apparent from the result shown in FIG. 6, although the relative density is 95% or more at a sintering temperature of 850° C. or more, when the sintering temperature exceeds 1,000° C., the PbO diminution increases and the relative density decreases.

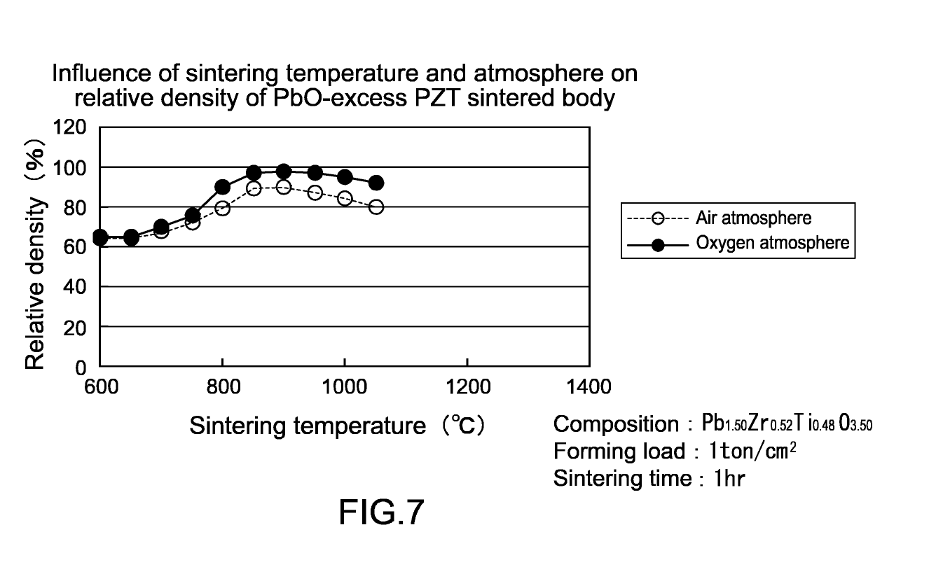

FIG. 7 is a graph showing an experimental result that shows an influence of the sintering temperature used in the sintering process of Step 105 on the relative density of the PbO-excess PZT sintered body in the air atmosphere and the oxygen atmosphere at around normal pressure. In the experiment, the PZT powder having the stoichiometric composition was preformed at 1 ton/cm² and sintered in the air atmosphere and the oxygen atmosphere for 1 hour each thereafter. In the figure, the black circles represent the relative density in the oxygen atmosphere, and the white circles represent the relative density in the air atmosphere. It can be seen from the result shown in FIG. 7 that because a sintering atmosphere of the pre-sintered body is the oxygen atmosphere, sintering at a higher temperature becomes possible, which is a more desirable condition in which no composition fluctuation is caused.

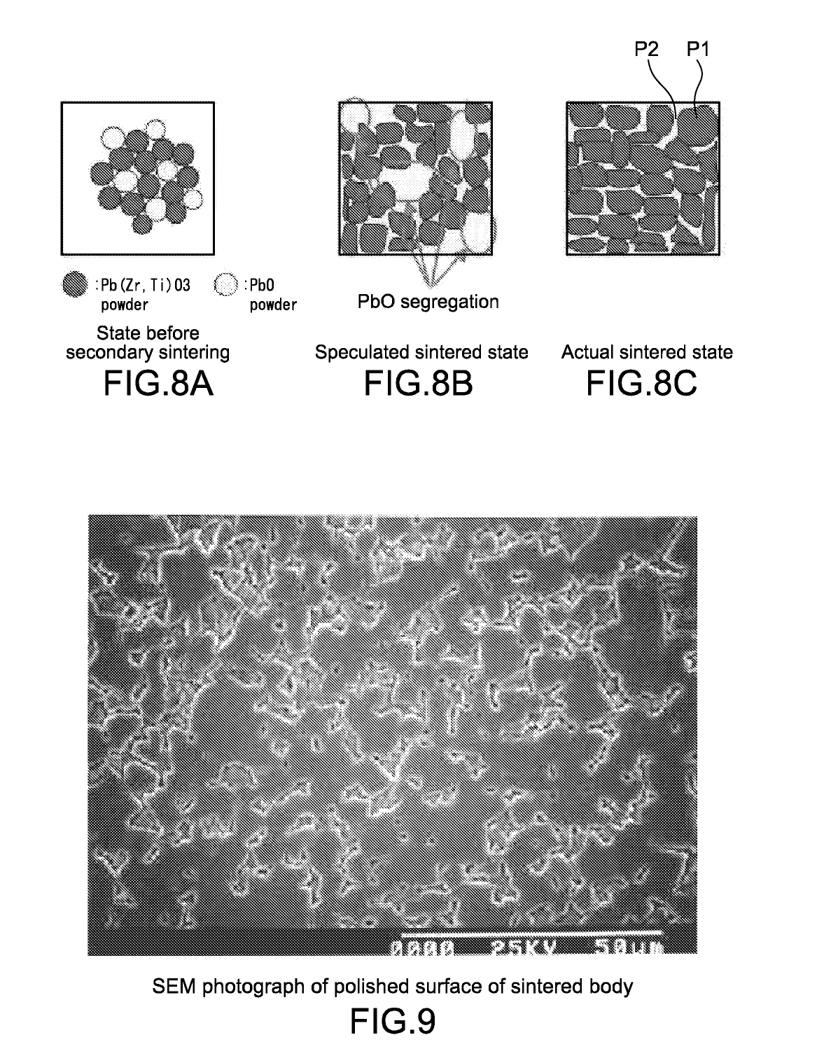

FIGS. 8A to 8C are diagrams schematically showing a sintered state of the sintered body obtained by the sintering process of Step 105. Here, FIG. 8A shows a state before being sintered, FIG. 8B shows a speculated sintered state, and FIG. 8C shows an actual sintered state. FIG. 9 shows a SEM photograph of PZT obtained after polishing the sintered body whose composition is Pb_{1.50}Zr_{0.52}Ti_{0.48}O_{3.30}, and subjecting the resultant to thermal etching (annealing treatment) at 750° C. for 0.5 hour thereafter. A uniform organization can be observed. A spaced area between particles is an area where excessive PbO has been present. It can be seen from the figure that excessive PbO is also distributed favorably.

Since a melting point of PbO itself is 888° C., it has been presumed that, depending on the excess PbO content, melting occurs locally at a temperature around the melting point, and non-uniform sintering progresses. However, by employing the method of producing a sintered body of the present invention described above, it has been confirmed that a precise sintered body can actually be obtained. It should be noted that under the temperature condition of 800° C. or less, the sintering of PbO took a long time, and the relative density was not increased even when the temperature was maintained for a time period about several times the time period that had been considered adequate.

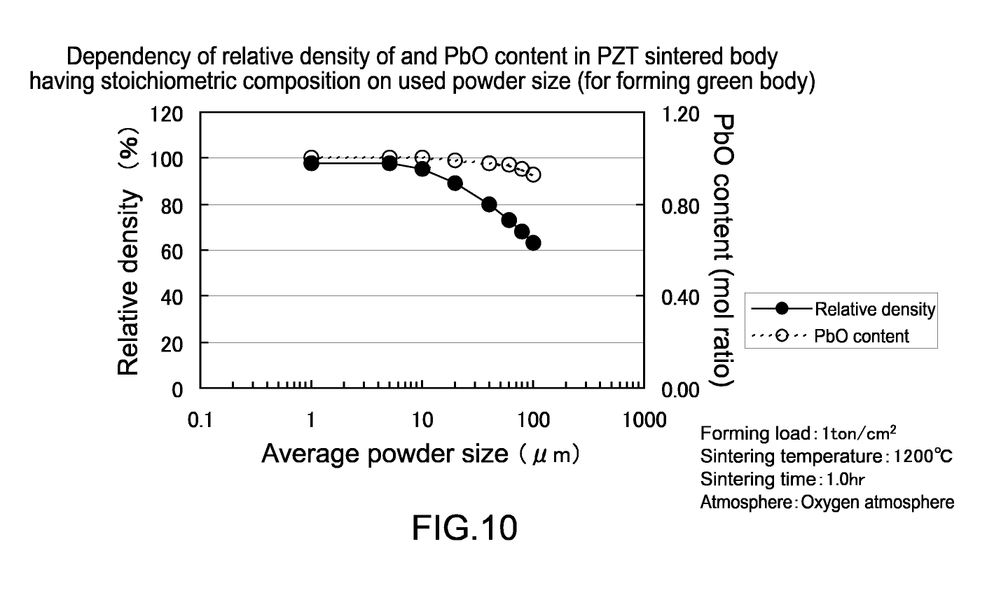

In the forming process of Step 104, the powder size of the powder obtained by pulverizing the pre-sintered body is desirably 5 μm or less. FIG. 10 is a graph showing an experimental result that shows an influence of an average powder size of PZT on the relative density of and PbO content in the PZT sintered body having the stoichiometric composition. In the experiment, the PZT powder having the stoichiometric composition was preformed at 1 ton/cm² and sintered at 1,200° C. for 1 hour in the oxygen atmosphere thereafter at around normal pressure. In the figure, the black circles represent the relative density, and the white circles represent the PbO content. It can be seen that when the average powder size is 5 μm or less, the relative density is high and the reduction of the PbO content is suppressed.

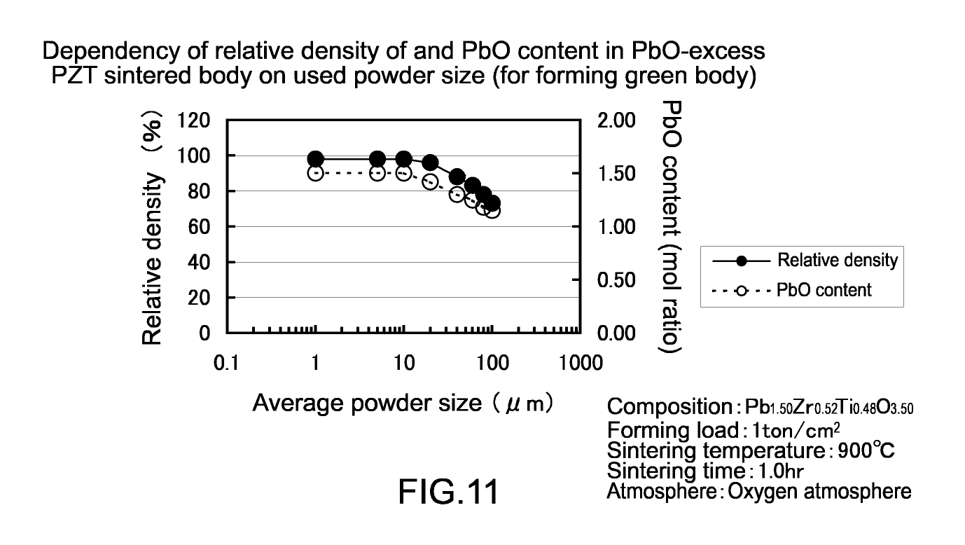

On the other hand, FIG. 11 is a graph showing an experimental result that shows an influence of an average powder size of PbO powder before sintering on the relative density of and PbO content in the PbO-excess PZT sintered body. In the experiment, the mixed powder in which the excess PbO content is 0.5 at a mol ratio was preformed at 1 ton/cm² and sintered at 900° C. for 1 hour in the oxygen atmosphere thereafter at around normal pressure. In the figure, the black circles represent the relative density, and the white circles represent the PbO content. It can be seen from the result shown in FIG. 11 that the sintering progresses less as the powder size increases, resulting in lowering of the density. The decrease of the PbO content is considered to be due to the fact that the PbO volatilization amount increased due to the heating, since the preform has a low density. The average powder size of PbO is 10 μm or less, more desirably 5 μm or less.

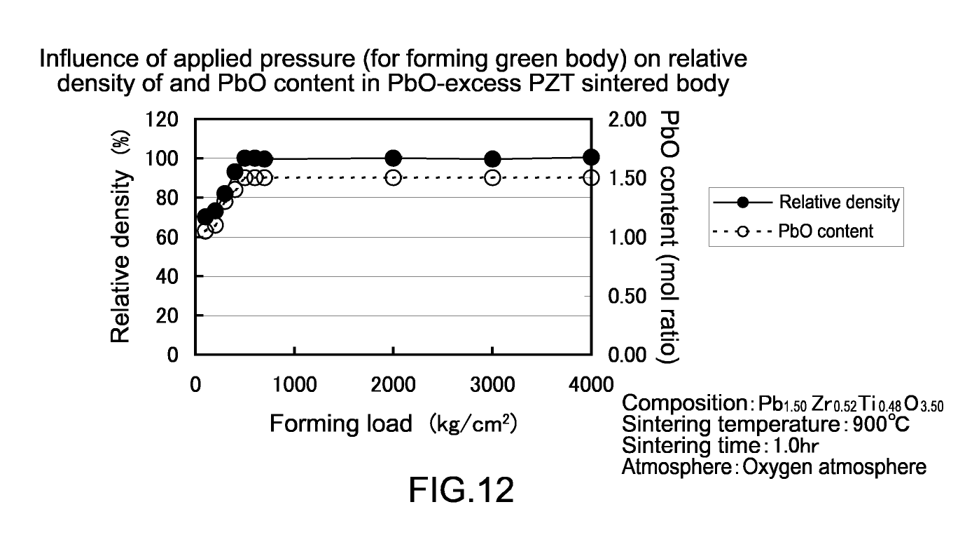

Also in producing the preform in Step 104, the forming pressure of the mixed powder obtained by mixing the powder having the stoichiometric composition and the PbO powder is preferably 500 kg/cm² or more. FIG. 12 is a graph showing an experimental result that shows an influence of the forming load on the relative density of and PbO content in the PbO-excess PZT sintered body at the time when the mixed powder in which the excess PbO content is 0.5 at a mol ratio is sintered at 900° C. for 1 hour in the oxygen atmosphere at around normal pressure. As is apparent from the result shown in FIG. 12, due to the forming load of 500 kg/cm² or more, a uniform PbO-excess PZT in which the relative density is 90% or more and a change of the PbO content is hardly observed can be obtained.

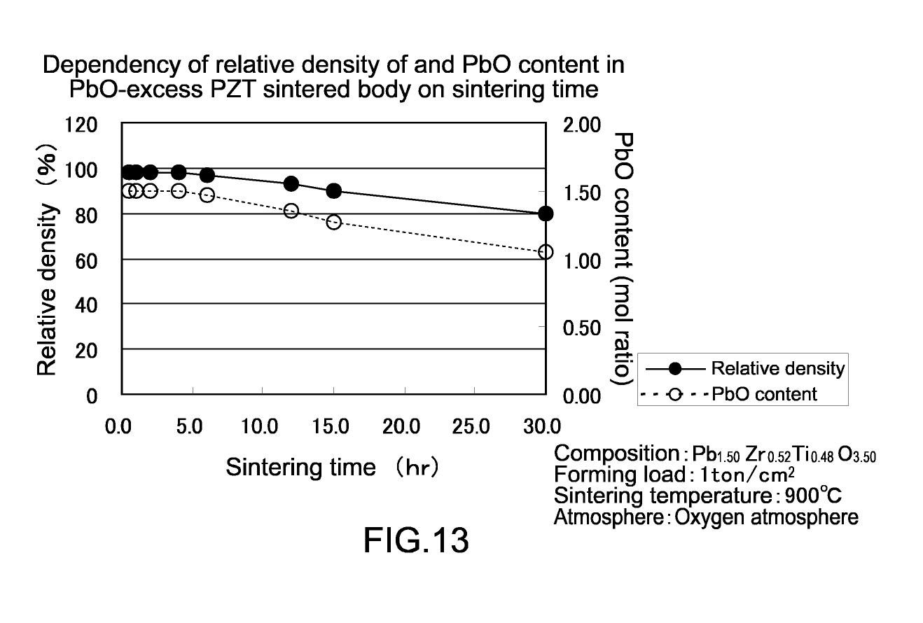

In addition, a sintering time in the sintering process of Step 105 was discussed. FIG. 13 is a graph showing an experimental result that shows an influence of the sintering time on the relative density of and PbO content in the PbO-excess PZT sintered body at a time when mixed powder in which powder of a pre-sintered body sintered at 1,200° C. is mixed with PbO powder is preformed. In the experiment, the mixed powder in which the excess PbO content is 0.5 at a mol ratio was preformed at 1 ton/cm² and sintered at 900° C. for 0.5 to 30 hours in the oxygen atmosphere at around normal pressure. As is apparent from the result shown in FIG. 13, with the time of 0.5 hour or more and 3 hours or less, the relative density and PbO concentration were constant and no large change was observed.

The PbO-excess PZT sintered body can be produced as described above. Moreover, a sputtering target is constituted by cutting out the PZT sintered body in a predetermined shape and bonding it to a backing plate (not shown).

According to this embodiment, because the sintering process is divided into two stages, a PbO-excess PZT sintered body that includes a uniform 2-phase mixed organization structure constituted of a first crystalline phase P1 formed of PZT having the stoichiometric composition and a second crystalline phase P2 formed of PbO distributed in the first crystalline phase P1, and has a high relative density, as shown in FIGS. 8C and 9, can be obtained.

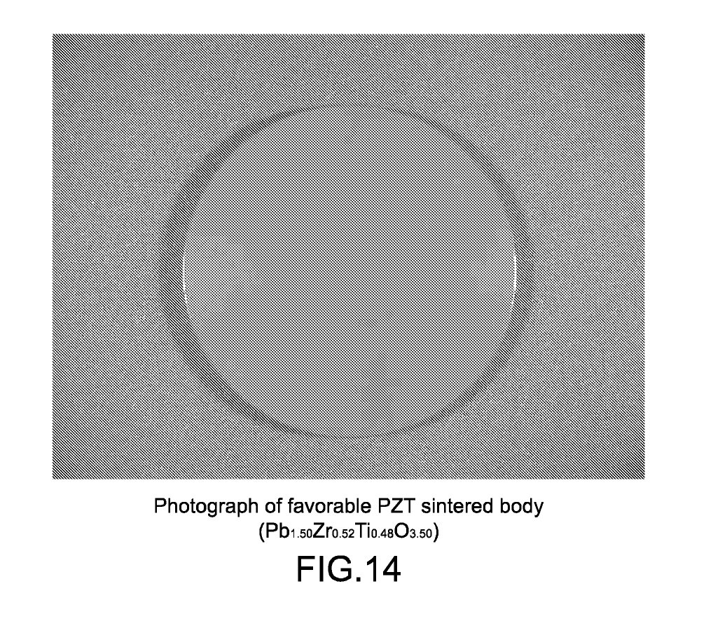

FIG. 14 is a photograph showing an outer appearance of the PZT sintered body obtained by preforming the raw material powder having the stoichiometric composition, pre-sintering (calcining) the preform at 1,200° C., pulverizing the pre-sintered body, adding excessive PbO thereto and mixing it to obtain Pb_{1.50}Zr_{0.52}Ti_{0.48}O_{3.50}) forming the resultant at 1 ton/cm², and sintering it at 900° C. for 1 hour. Further, FIG. 9 is a SEM photograph taken after the PZT sintered body is polished and subjected to the annealing treatment. According to this embodiment, it is possible to prevent a mixed organization of three phases or more, in which PbZrO₃, PbTiO₃, ZrO₂, TiO₂, PbO, and other intermediate compounds intervene, from being generated. Accordingly, inconveniences such as a fluctuation of a voltage/current, generation of particles, and a crack of a target that are caused when carrying out deposition using the PZT sintered body as the sputtering target can be prevented from occurring.

Further, the PZT sintered body produced as described above was mechanically processed using a cutting machine and a grinding machine to thus form a sputtering target plate, and the sputtering target plate was then bonded to the backing plate. In this case, while 3 out of 10 targets were cracked with a low-density (80% or less) PZT sintered body of the related art, none were cracked with the PZT sintered body of this embodiment.

It should be noted that in the descriptions above, although the pressure-forming process and sintering process of the mixed powder have been carried out separately in the production of the PZT pre-sintered body having the stoichiometric composition and the production of the PbO-excess PZT sintered body, a hot-press method (vacuum high-temperature high-pressure sintering method) in which the pressure-forming and sintering are carried out at the same time may also be employed.

### EXAMPLES

Hereinafter, examples of the present invention will be described.

### Example 1

Raw material powders of PbO, ZrO₂, and TiO₂ were mixed at a mol ratio of Pb:Zr:Ti=1.00:0.52:0.48, and the mixed powder was subjected to hydrostatic pressure forming at a pressure of 1,000 kg/cm², to thus obtain a preform. The preform was put in an MgO crucible and pre-sintered at 1,200° C. for 1.0 hour in an oxygen atmosphere, to thus obtain a PZT pre-sintered body having a stoichiometric composition. The PZT pre-sintered body was then pulverized into powder having an average powder size of 5 μm, and PbO powder was added and mixed so that the mol ratio became 2.00:0.52:0.48. The obtained mixed powder was subjected to hydrostatic pressure forming at a pressure of 2,000 kg/cm². The obtained compact was placed on an MgO plate and sintered at 900° C. for 0.5 hour in the oxygen atmosphere, to thus obtain a PbO-excess PZT sintered body.

A measurement of a relative density of the PbO-excess PZT sintered body showed a result of 98.0%. Moreover, as a result of conducting a powder XRD measurement on a part of the PbO-excess PZT sintered body that has been changed into powder, only peaks of two phases of PZT and PbO were confirmed.

### Example 2

Raw material powders of PbO, ZrO₂, and TiO₂ were mixed at a mol ratio of Pb:Zr:Ti=1.00:0.52:0.48, and the mixed powder was subjected to hydrostatic pressure forming at a pressure of 1,000 kg/cm², to thus obtain a preform. The preform was put in an MgO crucible and pre-sintered at 1,100° C. for 1.0 hour in an oxygen atmosphere, to thus obtain a PZT pre-sintered body having a stoichiometric composition. The PZT pre-sintered body was then pulverized into powder having an average powder size of 5 μm, and PbO powder was added and mixed so that the mol ratio became 2.00:0.52:0.48. The obtained mixed powder was subjected to hydrostatic pressure forming at a pressure of 2,000 kg/cm². The obtained compact was placed on an MgO plate and sintered at 850° C. for 0.5 hour in the oxygen atmosphere, to thus obtain a PbO-excess PZT sintered body.

A measurement of a relative density of the PbO-excess PZT sintered body showed a result of 97.2%. Moreover, as a result of conducting a powder XRD measurement on a part of the PbO-excess PZT sintered body that has been changed into powder, only peaks of two phases of PZT and PbO were confirmed.

### Example 3

Raw material powders of PbO, ZrO₂, and TiO₂ were mixed at a mol ratio of Pb:Zr:Ti=1.00:0.52:0.48, and the mixed powder was subjected to hydrostatic pressure forming at a pressure of 1,000 kg/cm², to thus obtain a preform. The preform was put in an MgO crucible and pre-sintered at 1,100° C. for 1.0 hour in an oxygen atmosphere, to thus obtain a PZT pre-sintered body having a stoichiometric composition. The PZT pre-sintered body was then pulverized into powder having an average powder size of 5 μm, and PbO powder was added and mixed so that the mol ratio became 1.80:0.52:0.48. The obtained mixed powder was subjected to hydrostatic pressure forming at a pressure of 2,000 kg/cm². The obtained compact was placed on an MgO plate and sintered at 850° C. for 0.5 hour in the oxygen atmosphere, to thus obtain a PbO-excess PZT sintered body.

A measurement of a relative density of the PbO-excess PZT sintered body showed a result of 97.2%. Moreover, as a result of conducting a powder XRD measurement on a part of the PbO-excess PZT sintered body that has been changed into powder, only peaks of two phases of PZT and PbO were confirmed.

### Example 4

Raw material powders of PbO, ZrO₂, and TiO₂ were mixed at a mol ratio of Pb:Zr:Ti=1.00:0.52:0.48, and the mixed powder was subjected to hydrostatic pressure forming at a pressure of 1,000 kg/cm², to thus obtain a preform. The preform was put in an Al₂O₃ crucible and pre-sintered at 900° C. for 1.0 hour in an air atmosphere, to thus obtain a PZT pre-sintered body having a stoichiometric composition. The PZT pre-sintered body was then pulverized into powder having an average powder size of 5 μm, and PbO powder was added and mixed so that the mol ratio became 1.80:0.52:0.48. The obtained mixed powder was subjected to hydrostatic pressure forming at a pressure of 2,000 kg/cm². The obtained compact was placed on an MgO plate and sintered at 850° C. for 1.0 hour in the air atmosphere, to thus obtain a PbO-excess PZT sintered body.

A measurement of a relative density of the PbO-excess PZT sintered body showed a result of 95.3%. Moreover, as a result of conducting a powder XRD measurement on a part of the PbO-excess PZT sintered body that has been changed into powder, only peaks of two phases of PZT and PbO were confirmed.

### Example 5

Raw material powders of PbO, ZrO₂, and TiO₂ were mixed at a mol ratio of Pb:Zr:Ti=1.00:0.52:0.48, and the mixed powder was subjected to hydrostatic pressure forming at a pressure of 1,000 kg/cm², to thus obtain a preform. The preform was put in an MgO crucible and pre-sintered at 1,200° C. for 1.0 hour in an oxygen atmosphere, to thus obtain a PZT pre-sintered body having a stoichiometric composition. The PZT pre-sintered body was then pulverized into powder having an average powder size of 5 μm, and PbO powder was added and mixed so that the mol ratio became 1.50:0.52:0.48. The obtained mixed powder was subjected to hydrostatic pressure forming at a pressure of 2,000 kg/cm². The obtained compact was placed on an MgO plate and sintered at 900° C. for 1.0 hour in the oxygen atmosphere, to thus obtain a PbO-excess PZT sintered body.

A measurement of a relative density of the PbO-excess PZT sintered body showed a result of 96.2%. Moreover, as a result of conducting a powder XRD measurement on a part of the PbO-excess PZT sintered body that has been changed into powder, only peaks of two phases of PZT and PbO were confirmed.

### Example 6

Raw material powders of PbO, ZrO2, and TiO2 were mixed at a mol ratio of Pb:Zr:Ti=1.00:0.52:0.48, and the mixed powder was subjected to hydrostatic pressure forming at a pressure of 1,000 kg/cm², to thus obtain a preform. The preform was put in an MgO crucible and pre-sintered at 1,200° C. for 1.0 hour in an oxygen atmosphere, to thus obtain a PZT pre-sintered body having a stoichiometric composition. The PZT pre-sintered body was then pulverized into powder having an average powder size of 5 μm, and PbO powder was added and mixed so that the mol ratio became 1.30:0.52:0.48. The obtained mixed powder was subjected to hydrostatic pressure forming at a pressure of 2,000 kg/cm². The obtained compact was placed on an MgO plate and sintered at 850° C. for 1.0 hour in the oxygen atmosphere, to thus obtain a PbO-excess PZT sintered body.

A measurement of a relative density of the PbO-excess PZT sintered body showed a result of 95.1%. Moreover, as a result of conducting a powder XRD measurement on a part of the PbO-excess PZT sintered body that has been changed into powder, only peaks of two phases of PZT and PbO were confirmed.

### Example 7

Raw material powders of PbO, ZrO₂, and TiO₂ were mixed at a mol ratio of Pb:Zr:Ti=1.00:0.52:0.48, and the mixed powder was subjected to hydrostatic pressure forming at a pressure of 1,000 kg/cm², to thus obtain a preform. The preform was put in an MgO crucible and pre-sintered at 1,100° C. for 1.0 hour in an oxygen atmosphere, to thus obtain a PZT pre-sintered body having a stoichiometric composition. The PZT pre-sintered body was then pulverized into powder having an average powder size of 5 μm, and PbO powder was added and mixed so that the mol ratio became 1.30:0.52:0.48. The obtained mixed powder was subjected to hydrostatic pressure forming at a pressure of 2,000 kg/cm². The obtained compact was placed on an MgO plate and sintered at 900° C. for 1.0 hour in the oxygen atmosphere, to thus obtain a PbO-excess PZT sintered body.

A measurement of a relative density of the PbO-excess PZT sintered body showed a result of 97.2%. Moreover, as a result of conducting a powder XRD measurement on a part of the PbO-excess PZT sintered body that has been changed into powder, only peaks of two phases of PZT and PbO were confirmed.

### Example 8

Raw material powders of PbO, ZrO₂, and TiO₂ were mixed at a mol ratio of Pb:Zr:Ti=1.00:0.52:0.48, and the mixed powder was subjected to hydrostatic pressure forming at a pressure of 1,000 kg/cm², to thus obtain a preform. The preform was put in an MgO crucible and pre-sintered at 1,200° C. for 1.0 hour, to thus obtain a PZT pre-sintered body having a stoichiometric composition. The PZT pre-sintered body was then pulverized into powder having an average powder size of 5 μm, and PbO powder was added and mixed so that the mol ratio became 1.30:0.52:0.48. The obtained mixed powder was subjected to vacuum high-temperature high-pressure sintering (HP) at 850° C. for 1.0 hour, to thus obtain a PbO-excess PZT sintered body.

A measurement of a relative density of the PbO-excess PZT sintered body showed a result of 97.5%. Moreover, as a result of conducting a powder XRD measurement on a part of the PbO-excess PZT sintered body that has been changed into powder, only peaks of two phases of PZT and PbO were confirmed.

### Comparative Example 1

Raw material powders of PbO, ZrO₂, and TiO₂ were mixed at a mol ratio of Pb:Zr:Ti=1.00:0.40:0.60, and the mixed powder was subjected to hydrostatic pressure forming at a pressure of 1,000 kg/cm², to thus obtain a preform. The preform was put in an Al₂O₃ crucible and pre-sintered at 800° C. for 1.0 hour, to thus obtain a PZT pre-sintered body having a stoichiometric composition. The PZT pre-sintered body was then pulverized into powder having an average powder size of 5 μm, and PbO powder was added and mixed so that the mol ratio became 1.50:0.52:0.48. The obtained mixed powder was subjected to hydrostatic pressure forming at a pressure of 2,000 kg/cm². The obtained compact was placed on an MgO plate and sintered at 700° C. for 1.0 hour in the air atmosphere, to thus obtain a PbO-excess PZT sintered body.

A measurement of a relative density of the PbO-excess PZT sintered body showed a result of 74.5%. Moreover, as a result of conducting a powder XRD measurement on a part of the PbO-excess PZT sintered body that has been changed into powder, peaks indicating many other phases than two phases of PZT and PbO were confirmed.

### Comparative Example 2

Raw material powders of PbO, ZrO₂, and TiO₂ were mixed at a mol ratio of Pb:Zr:Ti=1.30:0.52:0.48, and the mixed powder was subjected to hydrostatic pressure forming at a pressure of 1,000 kg/cm², to thus obtain a preform. The preform was put in an MgO crucible and pre-sintered at 900° C. for 1.0 hour, to thus obtain a PZT pre-sintered body having a stoichiometric composition. The PZT pre-sintered body was then pulverized into powder having an average powder size of 5 μm and subjected to hydrostatic pressure forming at a pressure of 2,000 kg/cm². The obtained compact was placed on an MgO plate and sintered at 950° C. for 1.0 hour in the oxygen atmosphere, to thus obtain a PbO-excess PZT sintered body.

A measurement of a relative density of the PbO-excess PZT sintered body showed a result of 70.0%. Moreover, as a result of conducting a powder XRD measurement on a part of the PbO-excess PZT sintered body that has been changed into powder, peaks indicating many other phases than two phases of PZT and PbO were confirmed.

Of the examples above, Examples 1 to 8 each show a PbO-excess PZT sintered body produced by the method described in the embodiment of the present invention, whereas Comparative Example 1 shows a PbO-excess PZT sintered body sintered at a lower temperature. Moreover, Comparative Example 2 shows a PbO-excess PZT sintered body produced by the production method of the related art, that is, by adding excessive PbO at a stage of mixing the raw materials.

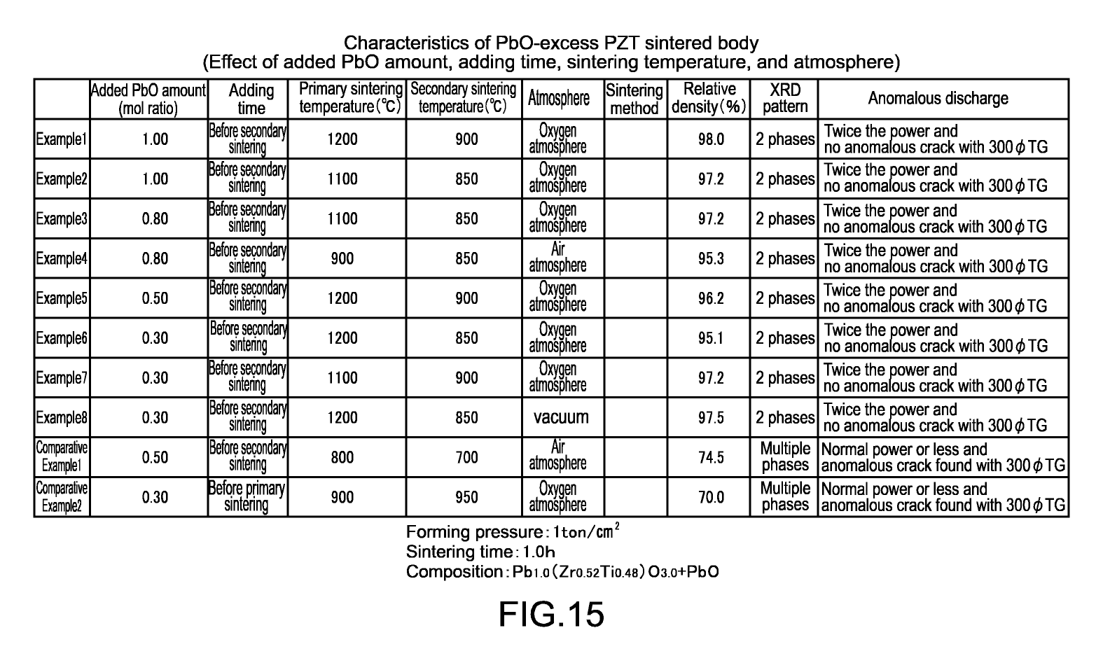

FIG. 15 shows a relative density and XRD pattern of the PbO-excess PZT sintered body produced in each of the examples above, and states of an allowable power load and anomalous discharge thereof when a target (TG) is produced from the sintered body and sputtered. Each of the PbO-excess PZT sintered bodies produced by the methods described in Examples 1 to 8 has a high relative density, electrical endurance, and physical strength. Each of the PbO-excess PZT sintered bodies produced by the methods described in Comparative Examples 1 and 2 has a low relative density and can only be applied a load of about a normal power density (21.2 W/cm²), and when applied as much or more, anomalous discharge is caused to thus break the target.

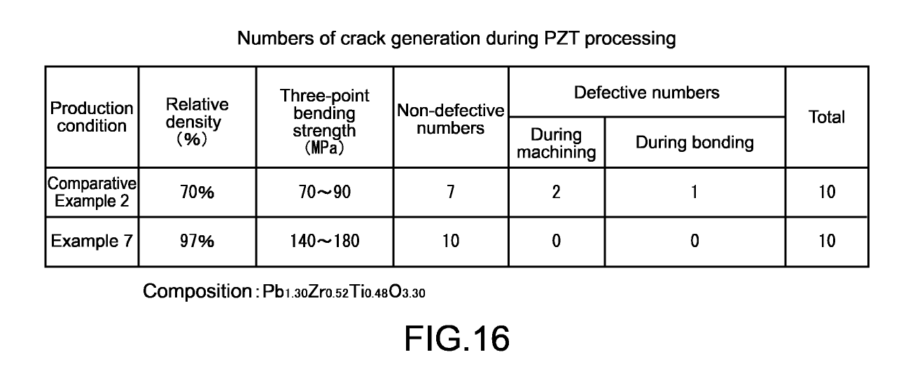

Meanwhile, the PZT sintered body produced by the method described in Example 7 (relative density of 97%) and the PZT sintered body produced by the method described in Comparative Example 2 (relative density of 70%) were compared for its mechanical strength. In the experiment, the number of defective sintered bodies (generation of cracks in sintered bodies) at a time of processing the sintered body into a target and a time of bonding the sintered body to the backing plate was checked. FIG. 16 shows the result of the experiment, which indicates that 3 out of 10 were defective for the sintered bodies according to Comparative Example 2, and none showed any deficiency for the sintered bodies according to Example 7. This is probably due to a difference between the relative densities of the sintered bodies. In addition, it was confirmed that a bending strength of the sintered body according to Example 7 was about twice the bending strength of the sintered body according to Comparative Example 2 (FIG. 16).

What is claimed is:

1. A method of producing a lead zirconium titanate-based sintered body, comprising:
producing a pre-sintered body by sintering raw material powder of lead zirconium titanate in which PbO, ZrO₂, and TiO₂ are mixed to have a stoichiometric composition, at a temperature of 900° C. or more and 1,200° C. or less;
pulverizing the pre-sintered body;
producing lead-excessive mixed powder by adding PbO powder to powder obtained by pulverizing the pre-sintered body; and
sintering the lead-excessive mixed powder at a temperature lower than the sintering temperature of the pre-sintered body.

2. The method of producing a lead zirconium titanate-based sintered body according to claim 1,
wherein the producing of the pre-sintered body includes forming the raw material powder at a pressure of 500 kg/cm² or more.

3. The method of producing a lead zirconium titanate-based sintered body according to claim 2,
wherein, in the producing of the pre-sintered body, the raw material powder is sintered in an oxidizing atmosphere.

4. The method of producing a lead zirconium titanate-based sintered body according to claim 1,
wherein, in the pulverizing of the pre-sintered body, the pre-sintered body is pulverized to have an average powder size of 5.0 μm or less.

5. The method of producing a lead zirconium titanate-based sintered body according to claim 1,
wherein, in the producing of the lead-excessive mixed powder, the PbO powder having an average powder size of 5.0 μm or less is added to the powder obtained by pulverizing the pre-sintered body.

6. The method of producing a lead zirconium titanate-based sintered body according to claim 1,
wherein, in the sintering of the lead-excessive mixed powder, the lead-excessive mixed powder is formed at a pressure of 500 kg/cm² or more, and the lead-excessive mixed powder is sintered at a temperature of 850° C. or more and 1,000° C. or less.

7. The method of producing a lead zirconium titanate-based sintered body according to claim 6,
wherein, in the sintering of the lead-excessive mixed powder, the lead-excessive mixed powder is sintered in an oxidizing atmosphere.
